(19) United States
(12) Patent Application Publication
(10) Pub. No.: US 2024/0151284 A1
(43) Pub. Date: May 9, 2024

(54) Brake piston pushback (step-back) mechanism

(71) Applicant: Vasile Vintila, Loxahatchee, FL (US)

(72) Inventor: Vasile Vintila, Loxahatchee, FL (US)

(21) Appl. No.: 18/500,207

(22) Filed: Nov. 2, 2023

Related U.S. Application Data
(60) Provisional application No. 63/382,111, filed on Nov. 3, 2022.

(30) Foreign Application Priority Data
Nov. 3, 2022 (US) US 63/382111

(51) Int. Cl. F16D 65/18

(52) U.S. Cl. CPC F16D 65/18; F16D 2121/04

(57) ABSTRACT

This concept has addressed the brake dust emission and the brake drag issues by introducing a pushback ring (press-fit on the brake piston) which pushes against the brake piston dust shield (or another elastic element if needed) when brake fluid pressure is created, thus accumulating a reactive force which is used to bring the brake piston to its original position when the brake fluid pressure is released and considerably reduce or eliminate the brake drag and the brake dust emission of any automobile in order to improve the fuel/energy consumption.

This concept is designed to push back the brake piston after a brake application, by a travel distance deemed to be optimal by the user.

The purpose is to considerably reduce or eliminate the brake drag and the brake dust emission, thus improving the vehicle's fuel/energy consumption.

### DRAWINGS

FIG. 1 (Assembly) is a representation of all the components, assembled together.

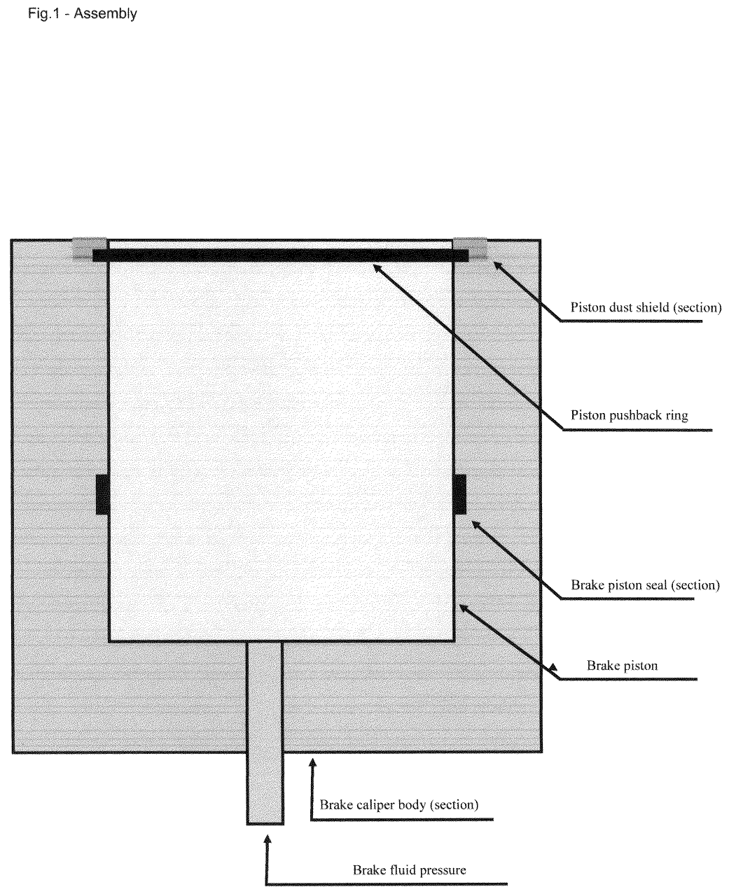

FIG. 2 (Dust shield) is a representation of the brake piston dust shield which is mounted and secured inside the brake caliper bore.

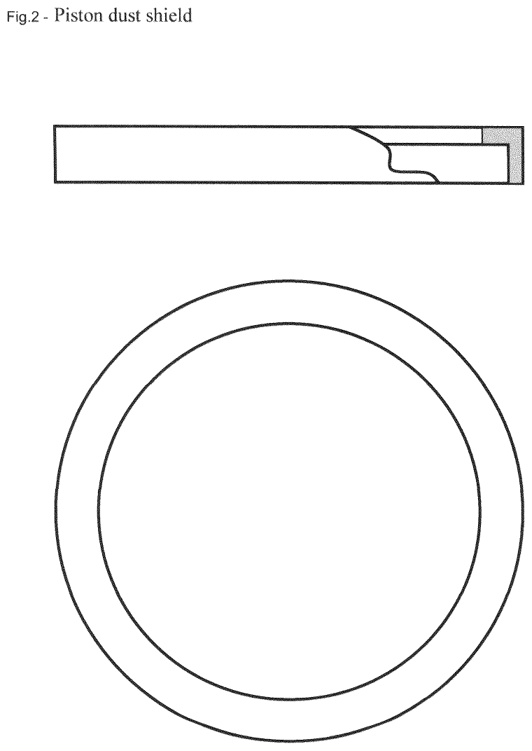

FIG. 3 (Pushback ring/element) is a representation of the pushback ring (element) which is press-fitted on the brake piston.

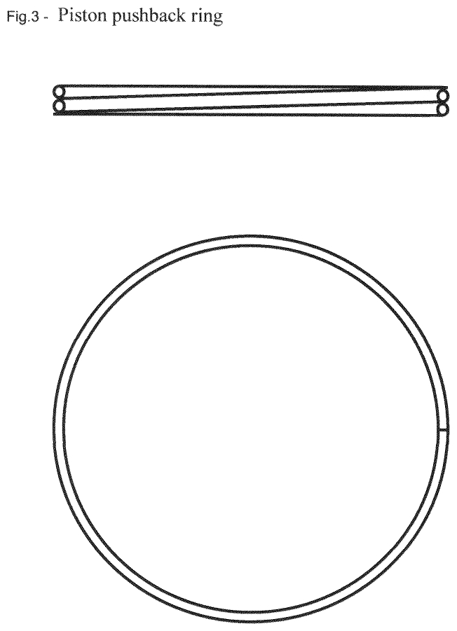

### DESCRIPTION AND OPERATION

The brake piston is press-fitted with a pushback ring, which can slide along the piston when pushed with a certain force.

The pushback ring can be coil-type or cylindrical type, to create a certain clamping force onto the piston. Both the piston and the ring will be built with compatible materials for a compatible behavior, depending on the brakes' temperature.

The dust shield has a dual purpose: to prevent water/debris ingress and to create resistance against the pushback ring when the brake piston is advancing. The dust shield has a certain degree of elasticity to accumulate a certain amount of tension in order to allow the piston to advance slightly when the brake pedal is pressed, but it has a limited distortion and becomes rigid when past a certain distortion limit.

When the brake pedal is pressed, the piston will cause the pushback ring to push against the inner side of the dust shield. The dust shield will accumulate a certain amount of tension and distortion, due to its elasticity. If the brake pedal is released, the dust shield will push back the piston/ring assembly to the original position.

When the brake fluid pressure is strong enough to move the piston forward and overcome the clamping force of the pushback ring, the ring will slide along the piston allowing it to advance and compensate for the brake pad wear until braking is achieved. When the brake pedal is released, the tension and distortion accumulated in the dust shield will push back the piston/ring assembly. Depending on the brake pad wear, the piston will advance by a certain amount, until braking is achieved.

When the brake pedal is released, the tension and the distortion accumulated in the dust shield will push the piston back to the relaxed position, thus creating a space between the brake pad and the brake rotor. This space can be adjusted through dust shield design.

The amount of force needed to distort the dust shield needs to be higher than the amount of force needed to push back the brake piston when the brake pedal IS NOT pressed.

The amount of force needed to slide back the pushback ring along the brake piston needs to be higher than the force needed to distort the dust shield until it becomes rigid.

The dust shield can be mounted on the brake caliper by means of a helical thread or it can be press-fitted as to give way when the brake pressure reaches a certain threshold in case the pushback ring will ever get stuck and won't slide along the brake piston. This will offer an extra layer of security to assure proper brake application in any situation.

When the brake pads will need to be replaced, the piston can be pushed back to its original position, thus resetting the whole assembly and getting it ready for a new cycle.

The distance between the pushback ring and the brake piston seal needs to be big enough to ensure that they will not slide on the same area of the brake piston, in order to preserve the life of the brake piston seal.

The advantages of this concept are:
protects the environment by improving the vehicle's efficiency and considerably reducing or eliminating the brake dust emission,
reduces the fuel or the energy consumption by considerably reducing or eliminating the brake drag,
compatibility with any hydraulic brake system currently in use,
simplicity and reliability during normal service life of a hydraulic brake system,
it is maintenance free and inexpensive to manufacture,
it is serviceable and can be reset and ready for a new cycle when the brake pads will be replaced.

1. A pushback ring or element is press-fitted on the brake piston in order to create/accumulate a reactive force when the brake pedal is pressed and the brake piston advances, pushing the ring against the brake piston dust shield. There is no friction between the pushback ring and the brake caliper bore and the pushback ring is able to slide along the brake piston when the reactive force created overcomes the friction between the pushback ring and the brake piston, allowing the brake piston to advance towards the brake disc,

2. The reactive force described in claim 1 is used to push back the brake piston when the brake pressure (pedal) is released and for special applications, if needed, an elastic element can be introduced between the pushback ring and the brake piston dust shield in order to achieve a specific pushback effect,

3. For correct operation, the reactive force needed to push back the brake piston when the brake pressure (pedal) is released is weaker than the force needed to slide the pushback ring along the brake piston and the latter is weaker than the force needed to dismount the brake piston dust shield, as a safety measure in case the pushback ring gets stuck and doesn't allow the brake piston to advance towards the brake disc.
